(19) United States
(12) Patent Application Publication
(10) Pub. No.: US 2008/0244607 A1
(43) Pub. Date: Oct. 2, 2008

(54) Economic allocation and management of resources via a virtual resource market

(76) Inventors: Vladislav Rysin, New York, NY (US); Steven W. Yatko, Upper Saddle River, NJ (US); Chris Swan, Bolnore Village (GB)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(21) Appl. No.: 11/900,424

(22) Filed: Sep. 11, 2007

Related U.S. Application Data
(60) Provisional application No. 60/908,350, filed on Mar. 27, 2007.

(51) Int. Cl. G06F 9/46

(52) U.S. Cl. 718/104

(57) ABSTRACT

Allocating distributed computing resources comprises creating offers to provide the resources for use by application programs. Each offer specifies a performance characteristic and a value associated with a corresponding resource. Bids to obtain the resources for use by the application programs are created. Each bid specifies a service level required for operation of a corresponding application program and a value associated with operating the corresponding application program. Bids are matched to offers via a market exchange model by matching the service level requirement and value of each bid to the performance characteristic and value of one of the offers. Resources associated with each offer are allocated to the application program associated with a matching bid, and the application program's operations are migrated to the allocated resources. Resources are monitored to ensure compliance with the service level requirement of each bid, and non-complying resources are replaced via the market exchange model.

### RELATED APPLICATIONS

This patent application claims priority under 35 U.S.C. § 119 to U.S. Provisional Patent Application No. 60/908,350, entitled “Economic Allocation and Management of Resources Via a Virtual Resource Market,” filed Mar. 27, 2007, the complete disclosure of which is hereby fully incorporated herein by reference.

### TECHNICAL FIELD

The invention relates to allocating and managing distributed computing resources. More particularly, the invention relates to dynamic matching resource requirements with available resources via an economic market (for example, an exchange) and managing the available resources based on previous resource matching and current business economics.

### BACKGROUND

In an enterprise organization, distributed computing resources, such as compute resources, network resources, and storage resources, are provided to operate multiple application programs. The distributed computing resources may be provided in one general location, in which case the resources communicate via one or more local area networks. Alternatively, the distributed computing resources may be provided in several locations, in which case the resources communicate via one or more local area networks and one or more wide area networks, such as the Internet.

The distributed computing resources can be allocated among application programs to accommodate the operations of those programs. For example, compute resources, network resources, and storage resources can be allocated to each application program, and each application program can utilize its allocated resources for its operation. However, conventional allocation methods allocate a particular resource to an application program based on whether the particular resource currently is underutilized and can accommodate the operations of an additional application program. In this manner, the operations of additional application programs are added to a resource until the resource is utilized to its maximum capacity or beyond.

Such conventional allocation of resources does not account for business or operational priorities, or operational requirements, or quality of service of the application programs. Accordingly, limited and valuable resources may be allocated to lower-priority application programs instead of to higher-priority applications simply because the lower-priority application programs were addressed first, before the higher-priority application programs. Additionally, such conventional allocation of resources does not result in an economically efficient distribution of resources based on the value accorded to specific resources by an application program or by the user of an application program. Thus, resources allocated via conventional methods may be under-utilized because those resources are consumed by application programs that cannot fully utilize the specific performance characteristics of the allocated resources. Alternatively, resources allocated via conventional methods may be under-performing because those resources are consumed by application programs that require more sophisticated performance characteristics than those of the allocated resources.

Furthermore, in conventional resource allocation methods, resources are not dynamically reallocated to maintain an efficient and/or economical distribution of the resources. Once resources are initially allocated to an application program, the application program operates on those resources indefinitely. When the resource becomes over-utilized as more and more application program operations are added to the resource, the conventional solution is to buy more resources. That conventional solution does not consider reallocating existing resources to locate unused capacity of the existing resources. That conventional solution also does not consider the need to dynamically migrate a program's operations to more suitable resources.

Accordingly, a need exists in the art for efficiently allocating resources among application programs. A need also exists for assigning and considering an economic value of resources to an application program to determine an allocation of resources to the application program. A further need exists for monitoring the performance of application programs on allocated resources to identify under-utilized or under-performing resources, thereby allowing a new allocation of more appropriate resources to application programs. Another need exists for managing resources based on previous resource allocations to guide investment and divestment decisions in those resources.

### SUMMARY

The invention includes methods and systems for allocating and managing distributed computing resources via a market exchange model. Utilizing the market exchange model can result in an efficient and economic allocation of the resources for use by application programs. The resources can be allocated based on market prices for units of each resource. Accordingly, offers to provide resources for use by application programs can be created, where each offer specifies at least one performance characteristic and a value associated with a corresponding unit of resource. Bids to obtain the resources for use by the application programs also are created. Each bid specifies at least one service level required for operation of a corresponding application program and a value corresponding to a perceived value associated with operating the corresponding application program or to a perceived value of obtaining a resource that meets or exceeds the service level requirements of the corresponding application program. Bids are matched to offers via the market exchange model by matching the service level requirement and value of each bid to the performance characteristic and value of one of the offers. Then, resources associated with each offer are allocated to the application program associated with a matching bid, and the application program's operations are migrated to the allocated resources. Resources are monitored to ensure compliance with the service level requirement of each bid, and non-complying resources are replaced via the market exchange model.

Performance monitoring can be performed for each application program that has been allocated resources in the distributed computing environment. In this manner, the performance of the allocated resources is continually or periodically monitored to ensure that the resources meet the service level requirements of the application program. If the resources are not providing the required level of service, then new bids can be created and submitted to the market exchange to obtain resources that will meet the service level requirements. Additionally, in this manner, the performance of the allocated resources is continually or periodically monitored to ensure that the performance of the resources does not exceed the service level requirements by an amount that would indicate an application program user is paying for unused resources (in other words, excess capacity of the resource). If the resources are not being sufficiently utilized by the application program, then new bids can be created and submitted to the market exchange to obtain resources that are more suitable and/or economical with regard to the service level requirements of the application program.

Thus, performance of allocated resources can be monitored to determine whether those resources are under-utilized or under-performing. If so, new resources can be identified and allocated to the application program, and the application program's operations can be migrated to the new resources, thereby providing the properly performing resources for the application program.

After the resources have been allocated as described previously over a period of time, information related to the allocated resources can be used to manage the resources. Profit and loss information for each of the resources is generated by subtracting actual or idealized costs and expenses for each resource from actual or idealized revenues generated by the resource during the relevant time period. Profit and loss information is compared to determine in which resources the owner should invest, in which resources the owner should maintain its current position, and which resources the owner should divest. The owner can invest in resources that are making a profit and can divest resources that are generating a loss.

Accordingly, an owner or user can evaluate physical resources to determine which resources are the most economical, including both price and performance. For example, compute resources can comprise different platforms that each has different price and performance characteristics. Comparison of the profit and loss statements of each resource for the time period will show which platforms are generating more revenue per unit of performance. Based on that information, the owner can determine which platforms to maintain or in which to increase the owner's position and which platforms to divest. Because the resources have been allocated as described previously, the evaluation provides an indication of which resources are more desirable, based on price and performance characteristics, for use by application programs.

These and other aspects, objects, and features of the invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for allocating and managing distributed computing resources according to an exemplary embodiment of the invention.

FIG. 2 is a flow chart depicting a method for allocating and managing distributed computing resources according to an exemplary embodiment of the invention.

FIG. 3 is a flow chart depicting a method for creating offers to provide available virtual resources at a specified price per unit of performance for each virtual resource according to an exemplary embodiment of the invention.

FIG. 4 is a flow chart depicting a method for identifying service level requirements required for operation of an application program according to an exemplary embodiment of the invention.

FIG. 5 is a flow chart depicting a method for creating bids to obtain units of resources required to meet the service level requirements of an application program according to an exemplary embodiment of the invention.

FIG. 6 is a flow chart depicting a method for matching resource offers to requirements bids to obtain virtual resources for use by an application program according to an exemplary embodiment of the invention.

FIG. 7 is a flow chart depicting a method for completing a transaction to purchase resources required for operation of an application program based on matching resource offers and requirements bids according to an exemplary embodiment of the invention.

FIG. 8 is a flow chart depicting a method for migrating an application program's operations to purchased resources according to an exemplary embodiment of the invention.

FIG. 9 is a flow chart depicting a method for monitoring the performance of allocated resources and the service level requirements of an application program according to an exemplary embodiment of the invention.

FIG. 10 is a block diagram depicting reallocation of distributed computing resources for an application program according to an exemplary embodiment of the invention.

FIG. 11 is a flow chart depicting a method for managing the maintenance, acquisition, and/or divestment of resources based on resource allocation over a period of time according to an exemplary embodiment of the invention.

### DETAILED DESCRIPTION OF EXEMPLARY EMBODIMENTS

Referring to the drawings, in which like numerals represent like elements, aspects of the exemplary embodiments will be described.

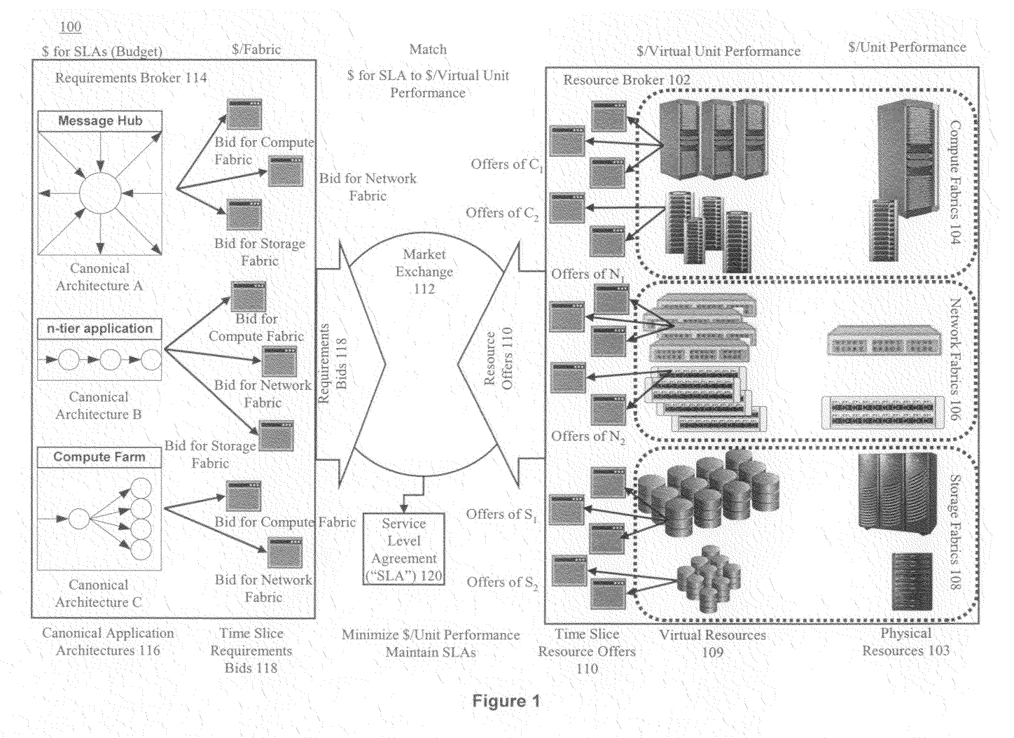

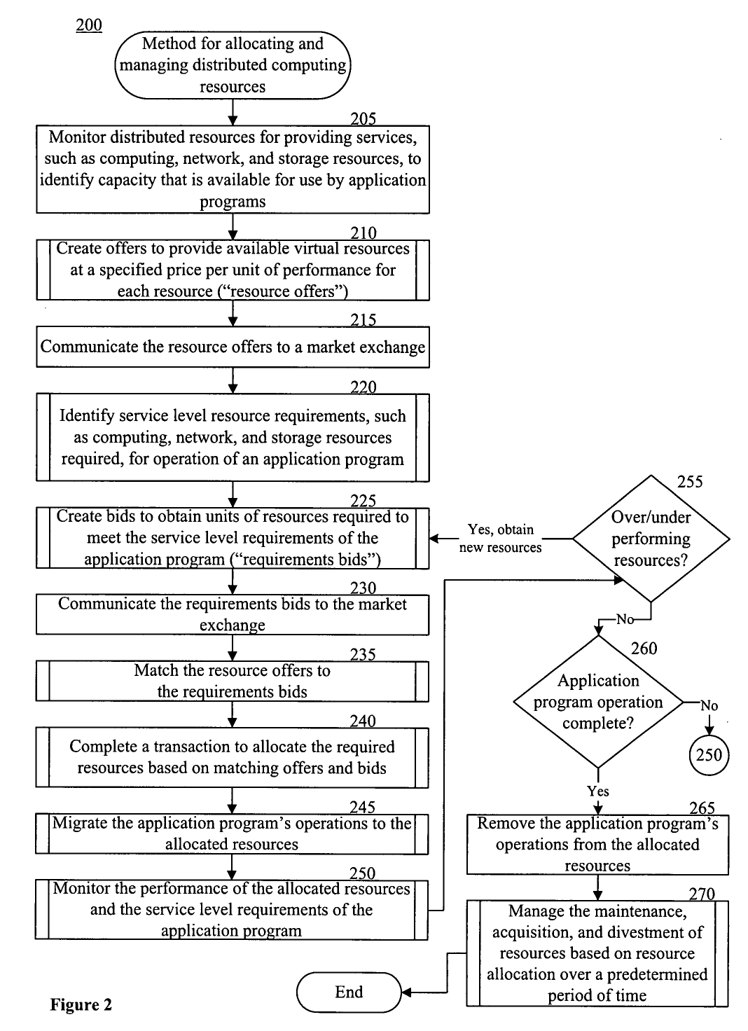

FIG. 1 is a block diagram depicting a system 100 for allocating and managing distributed computing resources according to an exemplary embodiment of the invention. The system 100 will be discussed in more detail with reference to the methods illustrated in FIGS. 2-9 and 11.

FIG. 2 is a flow chart depicting a method 200 for allocating and managing distributed computing resources according to an exemplary embodiment of the invention. The method 200 will be described with reference to FIGS. 1 and 2.

According to one exemplary embodiment, the distributed computing resources can be resources of an enterprise organization. In that case, users of the resources are members of the organization. Alternatively, the distributed computing resources can be resources of multiple organizations coupled to a central system for allocating those resources.

As illustrated in step 205 of FIG. 2, a resource broker 102 monitors distributed computing resources for providing computing services to identify resource capacity that is available to operate one or more application programs. In an exemplary embodiment, the distributed computing resources can comprise physical computing resources 103, such as compute fabrics 104, network fabrics 106, and storage fabrics 108. Each of the compute fabrics 104, network fabrics 106, and storage fabrics 108 can comprise one or more virtual resources 109 configured to provide services. For example, as illustrated in FIG. 1, the compute fabrics 104 comprise virtual compute fabrics C1 and C2, the network fabrics 106 comprise virtual network fabrics N1 and N2, and the storage fabrics 108 comprise virtual storage fabrics S1 and S2.

In an exemplary embodiment, the resource broker 102 can comprise a software module operating in the distributed computing environment and functioning as an interface between virtual resources 109 and a market exchange 112.

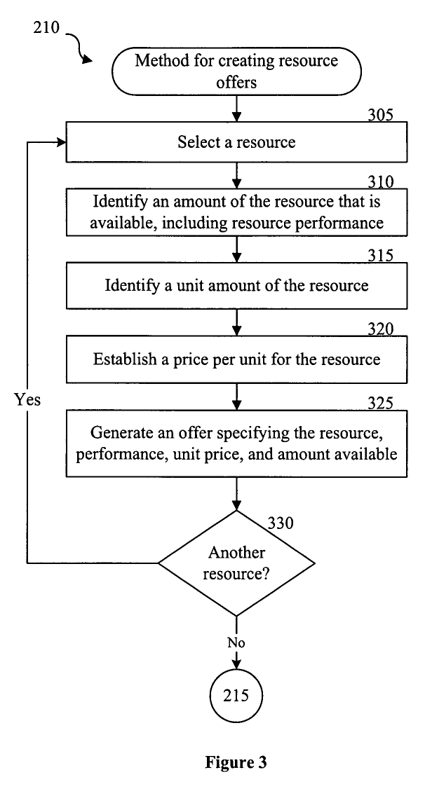

In step 210, the resource broker 102 creates offers to provide available virtual resources 109 at a specified price per unit of performance for each resource. Such offers are referred to herein as “resource offers 110” 110. One or more resource offers 110 can be created for each of the fabrics 104, 106, 108. For example, as illustrated in FIG. 1, the resource offers 110 comprise three offers of the compute fabric C₁, two offers of the compute fabric C₂, three offers of the network fabric N₁, two offers of the network fabric N₂, three offers of the storage fabric S₁, and two offers of the storage fabric S₂. Step 210 will be described in further detail hereinafter with reference to FIG. 3.

Then, in step 215, the resource broker 102 communicates the resource offers 110 to the market exchange 112. In an exemplary embodiment, the market exchange 112 can comprise a software module operating in the distributed computing environment and functioning as an interface between the resource broker 102 and a requirements broker 114.

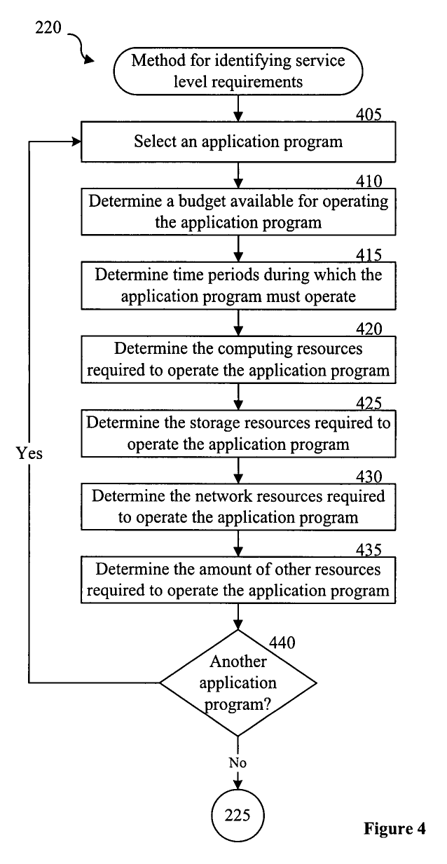

In step 220, the requirements broker 114 identifies service level resource requirements required for operation of an application program. In an exemplary embodiment, the required resources can comprise computing, network, and storage resources, such as one or more of the compute fabrics 104, network fabrics 106, and storage fabrics 108 illustrated in FIG. 1. Application programs can conform to well-established architectures, such as canonical application architectures 116. The exemplary canonical application architectures illustrated in FIG. 1 comprise a message hub illustrated as canonical architecture A, an n-tier application illustrated as canonical application architecture B, and a compute farm illustrated as canonical application architecture C. Other application architectures are within the scope of the invention. Step 220 will be described in further detail hereinafter with reference to FIG. 4.

In an exemplary embodiment, the requirements broker 114 can comprise a software module operating in the distributed computing environment and functioning as an interface between application programs and the market exchange 112.

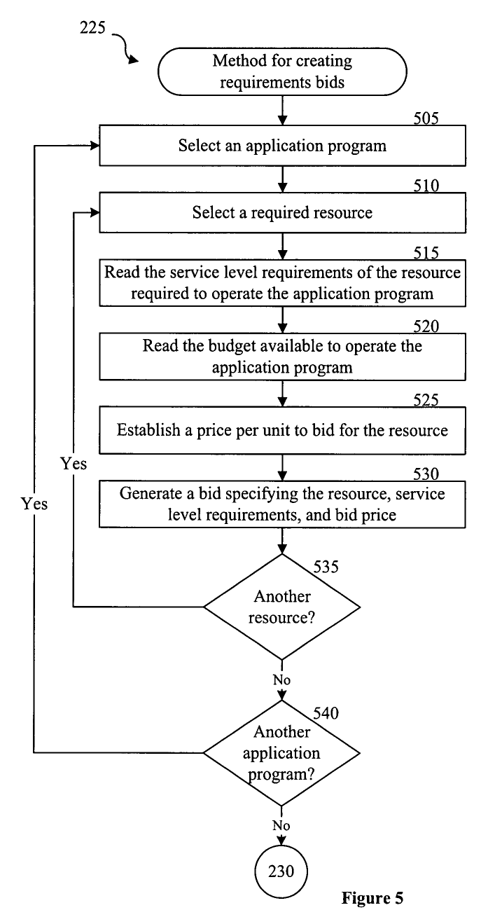

In step 225, bids to purchase units of resources required to meet the service level requirements of an application program are created. Such bids are referred to herein as “requirements bids 118.” One or more requirements bids 118 can be created for each application program. For example, as illustrated in FIG. 1, the requirements bids 118 comprise a bid for compute fabric, a bid for network fabric, and a bid for storage fabric for each canonical architecture A, B, C. Step 225 will be described in further detail hereinafter with reference to FIG. 5.

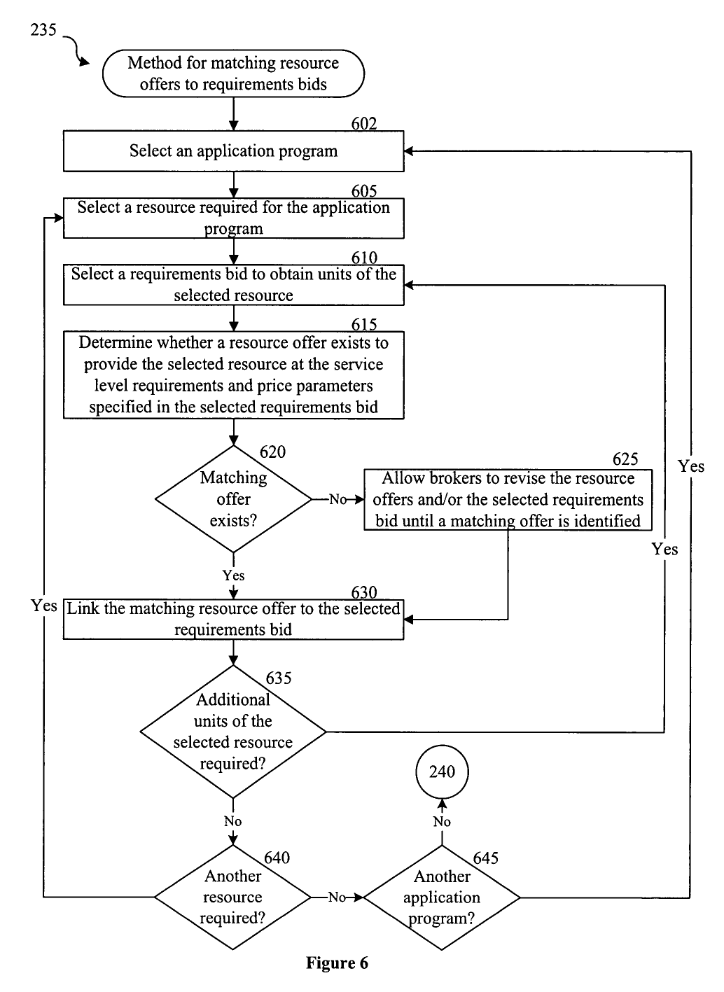

In step 230, the requirements broker 114 communicates the requirements bids 118 to the market exchange 112. Then, in step 235, the market exchange 112 matches the resource offers 110 to the requirements bids 118 to determine an economical and efficient allocation of the resources to each application program. Step 235 will be described in further detail hereinafter with reference to FIG. 6.

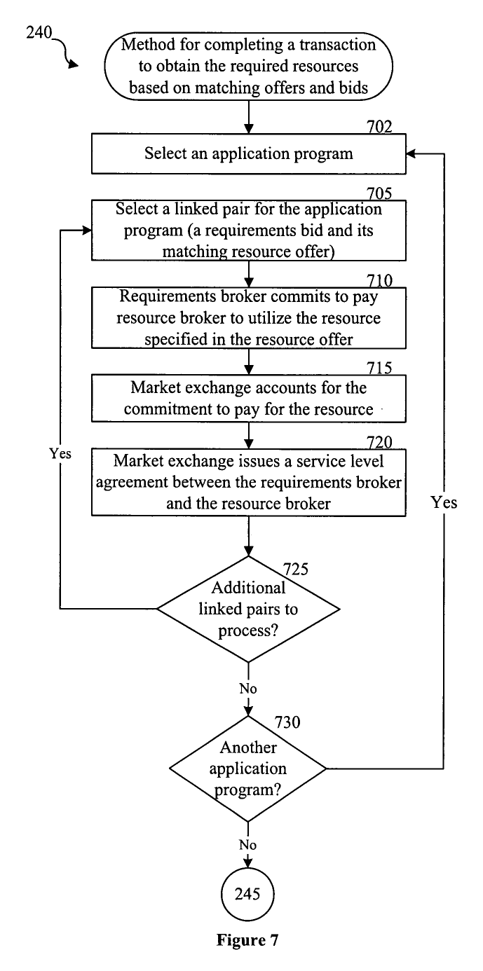

In step 240, the market exchange 112 completes a transaction to allocate the resources required for the application program based on matching offers and bids. Step 240 will be described in further detail hereinafter with reference to FIG. 7.

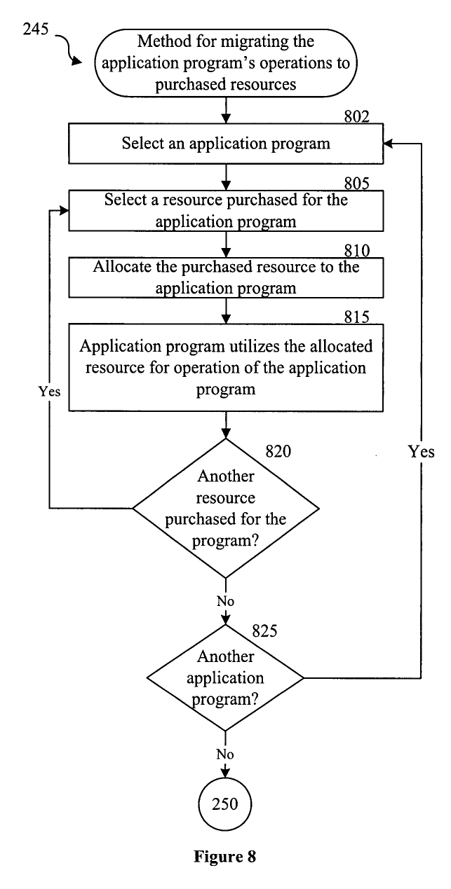

In step 245, the application program's operations are migrated to the allocated resources. Step 245 will be described in further detail hereinafter with reference to FIG. 8.

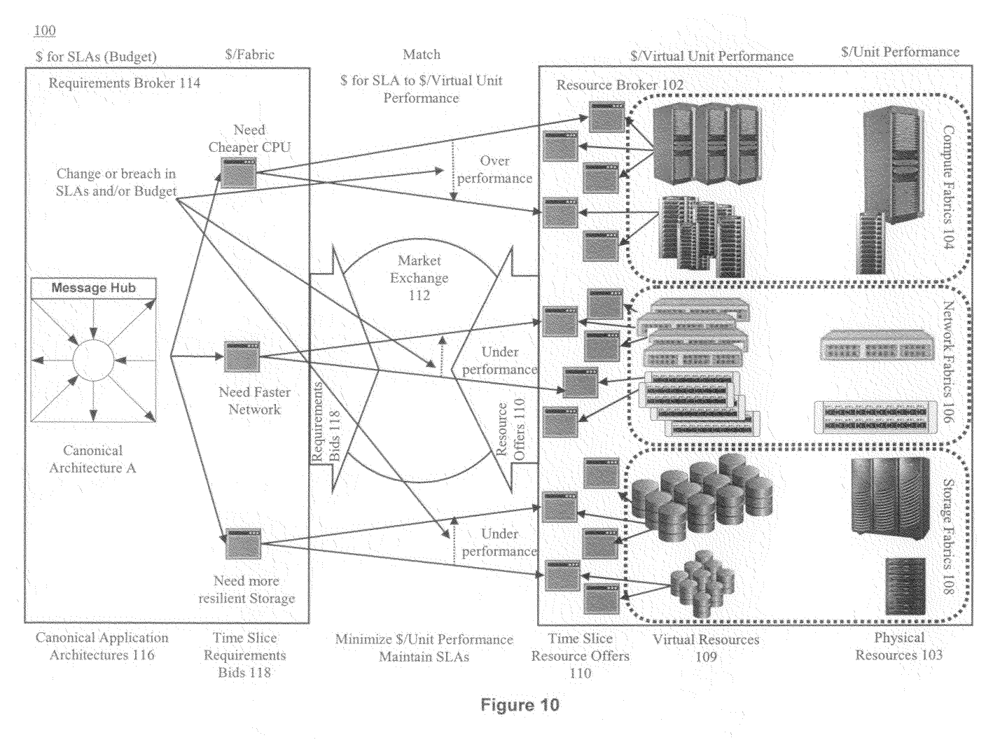

In step 250, the requirements broker 114 monitors the performance of the allocated resources and the service level requirements of each application program to insure that the performance of the allocated resources meets the service level requirements of each application program. Step 250 will be described in further detail hereinafter with reference to FIG. 10.

In step 255, based on the performance monitoring completed in step 250, the requirements broker 114 determines whether the allocated resources are under-utilized or underperforming with reference to the service level requirements of a particular application program. If yes, then the method 200 branches back to step 225 to obtain new resources that meet the service level requirements of the application program. If the requirements broker 114 determines in step 255 that the allocated resources meet the service level requirements of the application program, then the method branches to step 260.

In step 260, the method 200 determines whether operation of the application program is complete. If not, then the method 200 branches back to step 250 to continue monitoring the performance of the allocated resources and the service level requirements of the application program. If the method 200 determines in step 260 that the operation of the application program is complete, then the method 200 branches to step 265 in which the application program's operations are removed from the allocated resources.

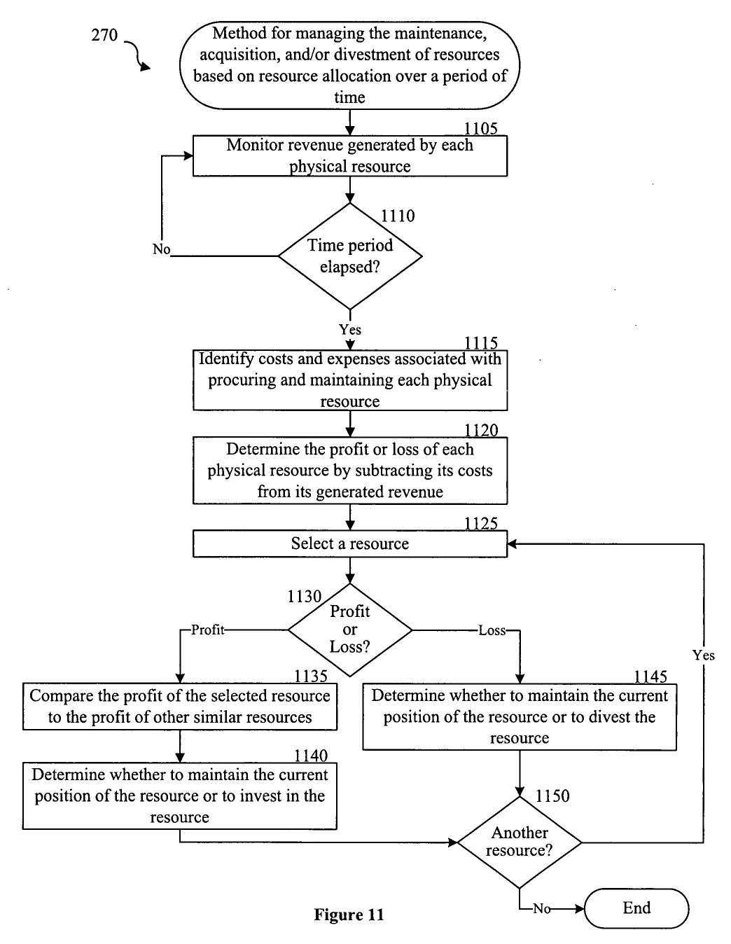

The method 200 also includes managing the maintenance, acquisition, and divestment of the resources based on resource allocation over a predetermined period of time, as illustrated in step 270 of FIG. 1. Step 270 will be described in further detail hereinafter with reference to FIG. 11.

FIG. 3 is a flow chart depicting a method 210 for creating offers to provide available virtual resources 109 at a specified price per unit of performance for each virtual resource 109 according to an exemplary embodiment of the invention, as referred to in step 210 of FIG. 2. The method 210 will be described with reference to FIGS. 1 and 3.

In step 305, the resource broker 102 selects a physical resource 103 that is available for use by an application program. For example, the resource broker 102 can select a compute, network, or storage resource, such as the compute fabrics 104, the network fabrics 106, and the storage fabrics 108. In an exemplary embodiment, the resource broker 102 can monitor the use of each resource to identify excess capacity of each resource that is not being utilized. Such excess capacity can be identified as resources that are available for use by an application program.

Then, in step 310, the resource broker 102 identifies an amount of the selected physical resource 103 that is available for use by an application program. In an exemplary embodiment, the amount of each resource can comprise a hardware type and/or configuration, including a specific manufacturer and/or component, as well as the excess capacity currently available for each resource. In this regard, available physical resources 103 can be combined to create virtual resources 109, such as the virtual compute fabrics C₁, C₂, the virtual network fabrics N₁, N₂, and the virtual storage fabrics S₁, S₂. For example, computer processors available at distributed locations can be aggregated to create a virtual computing resource that is available for use by an application program. Representative resource capacities can comprise CPU cycles for computing resources, bandwidth for network resources, and disk space and/or memory for storage resources.

The amount of resource available also can comprise performance and reliability characteristics associated with each virtual resource 109. For example, such characteristics can comprise execution time, response time, accuracy of results (such as fault rate), availability, reliability, security, or other suitable characteristics indicating the performance of the virtual resources 109.

In step 315, the resource broker 102 identifies a unit amount of the virtual resource 109 to include in an offer to provide the virtual resource 109 for use by an application program. In this regard, the resource broker 102 can identify portions of a virtual resource 109 that are available for allocation in increments of the identified unit up to the maximum amount of the virtual resource 109 that is available. If the resource broker 102 identified multiple virtual resources 109, such as the virtual compute fabrics C₁, C₂, in step 310, then the resource broker 102 can identify a unit amount for each virtual resource 109.

In step 320, a price is established for each unit of virtual resource 109 that will be included in an offer to provide the virtual resource 109 for use by an application program. In an exemplary embodiment, the resource broker 102 can calculate a price per unit of virtual resource 109 based on resource sophistication, cost data, supply, demand, or other economic data input into the resource broker 102 by a user or obtained by the resource broker 102 based on historical data of completed resource allocation transactions. For example, more sophisticated resources can be more expensive than less sophisticated resources, and high-demand resources can be more expensive than lower-demand resources. The price can comprise a monetary amount at which the resource will be sold for use by an application program. Alternatively, the value can represent a perceived value of the resource that is not based on actual monetary value. For example, the perceived value can be based on business requirements and priorities established within the business enterprise.

In step 325, the resource broker 102 generates one or more resource offers 110 to provide the available virtual resources 109 for use by an application program. The resource offers 110 can specify the virtual resource 109, the amount of virtual resource 109 available (including capacity and performance), and the unit price of the virtual resource 109, based on the information obtained in steps 310-320.

In step 330, the resource broker 102 determines whether to generate resource offers 110 for another virtual resource 109. For example, if the resource broker 102 has generated resource offers 110 for only available compute fabrics 104, then the resource broker 102 can decide to generate resource offers 110 for available network and storage fabrics 106, 108. In that case, the method 210 branches back to step 305 to generate resource offers 110 for another resource. If the method 210 determines in step 330 not to generate resource offers 110 for another virtual resource 109, then the method 210 branches to step 215 (FIG. 2).

FIG. 4 is a flow chart depicting a method 220 for identifying service level requirements required for operation of an application program according to an exemplary embodiment of the invention, as referred to in step 220 of FIG. 2. The method 220 will be described with reference to FIGS. 1 and 4.

In step 405, an application program is selected. Then, specific service level requirements for the selected application program are identified in steps 410-435.

In step 410, a budget available for operating the application program is identified. In an exemplary embodiment, the budget can be input by a user of the application program and designed to meet the user's budgetary constraints. For example, a user can input the budget available for operating the application program based on known funding for a particular program. In another exemplary embodiment, the budget information can comprise a value associated with operating the application program. The value can comprise a monetary amount that the user is willing to pay to obtain the resources necessary to operate the application program. Alternatively, the value can represent a perceived value of the application program that is not based on actual monetary value. For example, the perceived value can be based on a priority of the application program's operations to the user and/or to other users operating additional application programs within the distributed computing environment. Budget constraints can be provided in several alternative formats, such as commands to obtain the best resources available regardless of cost, to obtain the least expensive resources, to obtain resources at a specified total price or price per unit of resource, or to obtain resources via another suitable budget format.

In step 415, time periods during which the application program must operate are identified. In an exemplary embodiment, the time periods of operation can be input by a user of the application program and designed to meet the user's budgetary and customer service constraints. For example, a user can input the time periods during which the application program must operate, such as 24/7 (twenty-four hours per day, seven days a week), 24/5 (twenty-four hours per day, five days a week), 8:00 am to 5:00 pm Monday through Friday, or any other suitable time period during which the application program must operate. The user also can adjust the specified time periods of operation based on budgetary constraints. For instance, the user can specify operating the application program during off-peak time periods to reduce the cost of operating the application program.

In steps 420-435, computing resources, network resources, storage resources, and other resources required to operate the application program, respectively, are determined. According to an exemplary embodiment, steps 420-435 can comprise identifying a hardware type and/or configuration, including a specific manufacturer and/or component, as well as the capacity required for each resource. Representative resource capacities required can comprise CPU cycles for computing resources, bandwidth for network resources, and disk space and/or memory for storage resources. Steps 420-435 also can comprise identifying performance characteristics for each required resource to operate the application program within specific parameters. For example, such characteristics can comprise execution time, response time, accuracy of results (such as fault rate), availability, reliability, security, or other suitable characteristics indicating the performance of the resources.

In an exemplary embodiment, the requirements broker 114 can determine the required resources based on minimum or optimum resource requirements necessary to operate the application program as desired. In this case, the requirements broker 114 can obtain that information directly from the application program's specifications. Alternatively, a user of the application program can input desired, configurable settings to specify an amount of one or more of the resources. In this regard, the user can input characteristics that will provide a desired level of service, which the requirements broker 114 can read in steps 420-435.

According to exemplary embodiments, service level requirements can be expressed in terms of thresholds or ranges. For example, a required response time can be established at less than 1 second, which allows a future determination of whether a resource's performance meets the service level requirement threshold. An alternative example would be that a required response time can be established in a range such as 0.5 seconds to 1.5 seconds. In that case, a resource meets that service level requirement if its response time falls within the specified range. Performance thresholds and ranges can be specified for each service level requirement.

In step 440, the method 220 determines whether to identify service level requirements for another application program. If yes, the method 220 branches back to step 405 to select another application program for which it will identify service level requirements. In this regard, the method 220 can identify service level requirements for multiple application programs. For example, service level requirements can be identified for applications utilizing one of the canonical architectures A, B, C illustrated in FIG. 1. If the method 220 determines in step 440 that it will not identify service level requirements for another application program, then the method 220 branches to step 225 (FIG. 2).

The specific service level requirements described with reference to steps 410-435 can depend upon the specific requirements of a particular application program and the specific requirements of a user of the application program or the owner of the distributed computing resources. Accordingly, the service level requirement may comprise all, or a subset, of the items described in steps 410-435, and additional service level requirements are within the scope of the invention.

FIG. 5 is a flow chart depicting a method 225 for creating bids to obtain units of resources required to meet the service level requirements of an application program according to an exemplary embodiment of the invention, as referred to in step 225 of FIG. 2. The method 225 will be described with reference to FIGS. 1 and 5.

In step 505, the requirements broker 114 selects a first application program for which it will create one or more requirements bids 118. And, in step 510, the requirements broker 114 selects a first resource required for the operation of the selected application program. For example, the requirements broker 114 can select one of compute, network, or storage resources required for operation of the application program.

In step 515, the requirements broker 114 reads the service level requirements for the selected resource, based on the service level requirements determined in steps 415-435 of FIG. 4. Additionally, in step 520, the requirements broker 114 reads the budget information indicating the budget constraints for operating the application program, based on the budget determined in step 410 of FIG. 4.

Then, in step 525, the requirements broker 114 establishes a price per unit of the selected resource that it will pay to obtain the selected resource for operation of the application program, based on the service level requirements and the available budget. In an exemplary embodiment, the requirements broker 114 can calculate a price per unit of resource based on cost data, supply, demand, or other economic data input into the requirements broker 114 by a user or obtained by the requirements broker 114 based on historical data of completed resource allocation transactions. The requirements broker 114 also can establish a price per unit based on commands to obtain the best resources available regardless of cost, to obtain the least expensive resources, to obtain resources at a specified total price or price per unit of resource, or to obtain resources via another suitable budget format, depending on the budget information and the priority of the application program.

In step 530, the requirements broker 114 generates one or more requirements bids 118 to obtain the selected resource for use by the selected application program. The requirements bids 118 can specify the resource, the service level requirements that the resource must meet, and the unit price that the user will pay to obtain the resource, based on the information obtained in steps 515-525. As discussed previously, the unit price can comprise an actual monetary value or a perceived value.

In step 535, the requirements broker 114 determines whether to generate requirements bids 118 for another resource needed to operate the application program. For example, if the requirements broker 114 has generated requirements bids 118 for only compute resources, then the requirements broker 114 can decide to generate requirements bids 118 for network or storage resources. In that case, the method 225 branches back to step 510 to generate requirements bids 118 for another resource. If the method 225 determines in step 535 not to generate requirements bids 118 for another resource, then the method 225 branches to step 540.

Then, in step 540, the requirements broker 114 determines whether to generate requirements bids 118 for another application program. If yes, the method 225 branches back to step 505 to generate requirements bids 118 for another application program. If the method 225 determines in step 540 not to generate requirements bids 118 for another application program, then the method 225 branches to step 230 (FIG. 2).

FIG. 6 is a flow chart depicting a method 235 for matching resource offers 110 to requirements bids 118 to obtain virtual resources 109 for use by an application program according to an exemplary embodiment of the invention, as referred to in step 235 of FIG. 2. The method 235 will be described with reference to FIGS. 1 and 6.

In step 602, the market exchange 112 selects an application program for which it will identify resources available to operate the selected application program. And, in step 605, the market exchange 112 selects a resource required to operate the selected application program. More specifically, if multiple resources are required for operation of the selected application program, then the method 235 selects one of those resources in step 605, thereby allowing the method 235 to match a resource offer 110 to a requirements bid 118 for the selected resource. Then, as described hereinafter, the matching steps can be repeated for other resources that are needed for operation of the application program.

In step 610, the market exchange 112 selects a requirements bid to purchase units of the selected resource for the selected application program. Then, in step 615, the market exchange 112 determines whether a resource offer exists to provide virtual resources 109 at the service level requirements and price parameters specified in the selected requirements bid. Accordingly, in step 620, the market exchange 112 determines whether such a matching offer exists. If yes, then the method 235 branches to step 630. If not, then the method 235 branches to step 625 in which the market exchange 112 allows the resource and requirements brokers 102, 114 to revise the resource offers 110 and/or the selected requirements bid until a matching offer is identified. The method 235 then proceeds to step 630.

The methods employed by the market exchange 112 to identify resource offers 110 that match a selected requirements bid can comprise any suitable format for allocating goods in an economic market. For example, the market exchange 112 can utilize methods such as a commodity market model, posted price model, tendering/contract-net model, auction model (including a Dutch auction model), monopoly/oligopoly model, and/or a bid-based proportional resource sharing model. In these exemplary embodiments, the market exchange 112 operates an economic market to efficiently allocate resources at a market clearing price and within the budget parameters specified in the selected requirements bid.

When considering the budget parameters specified in the selected requirements bid, the market exchange 112 can compare resource offers to identify the best resource offer that meets the requirements bid. For example, if multiple resource offers offer an appropriate type of resource, the market exchange 112 can identify the best resource offer under the budget constraints, such as a requirements bid's command to obtain the best resources available regardless of cost, to obtain the least expensive resources, to obtain resources at a specified total price or price per unit of resource, or to obtain resources via another suitable budget format.

In step 630, the market exchange 112 links the matching resource offer to the selected requirements bid. Then, in step 635, the market exchange 112 determines whether additional units of the selected resource are required to operate the selected application program. For example, if the matching resource offer provides only a portion of the resource required to meet the service level requirements, then the market exchange 112 can determine that additional units of the selected resource are required. If yes, then the method 235 branches back to step 610 to select another requirements bid to purchase units of the selected resource at a specified price. The newly selected requirements bid can be a revised version of the previously selected requirements bid, with a quantity of the selected resource reduced by an amount equal to the amount of resource provided by the matching resource offer.

Referring back to step 635, if additional units of the selected resource are not required, then the method 235 branches to step 640. In step 640, the market exchange 112 determines whether another resource is required to operate the selected application program. For example, if the market exchange 112 has identified matching resource offers 110 for only compute resources, then the market exchange 112 can decide to identify matching resource offers 110 for network or storage resources needed to operate the application program. In that case, the method 235 branches back to step 605 to identify matching resource offers 110 for another resource. If the market exchange 112 determines in step 640 not to identify matching resource offers 110 for another resource, then the method 235 branches to step 645.

Then, in step 645, the market exchange 112 determines whether to match requirements bids 118 and resource offers 110 for another application program. If yes, the method 235 branches back to step 602. If not, then the method 235 branches to step 240 (FIG. 2).

FIG. 7 is a flow chart depicting a method 240 for completing a transaction to purchase resources required for operation of an application program based on matching resource offers 110 and requirements bids 118 according to an exemplary embodiment of the invention, as referred to in step 240 of FIG. 2. The method 240 will be described with reference to FIGS. 1 and 7.

In step 702, the market exchange 112 selects an application program. And, in step 705, the market exchange 112 selects a requirements bid and its matching resource offer for the application program. In step 710, the requirements broker 114 commits to pay the resource broker 102 to utilize the virtual resource 109 specified in the resource offer. In step 715, the market exchange 112 accounts for the commitment to pay for use of the virtual resource 109 by debiting an account of the requirements broker 114 and crediting an account of the resource broker 102. Then, in step 720, the market exchange 112 issues a service level agreement between the requirements broker 114 and the resource broker 102 in which the resource broker 102 agrees to provide the virtual resources 109 specified in the resource offer (including a commitment to meet the service level requirements specified in the matching requirements bid) in exchange for the payment of costs, if any, specified in the resource offer.

In step 725, the market exchange 112 determines whether additional matching requirements bids 118 and resource offers 110 exist for the application program. If yes, then the method 240 branches back to step 705 to complete a transaction for another resource required for operation of the application program. If not, then the method 240 branches to step 730.

In step 730, the market exchange 112 determines whether it will complete transactions to obtain resources for another application program. If yes, then the method 240 branches back to step 702 to select another application program. If not, then the method 240 branches to step 245 (FIG. 2).

FIG. 8 is a flow chart depicting a method 245 for migrating an application program's operations to purchased resources according to an exemplary embodiment of the invention, as referred to in step 245 of FIG. 2. The method 245 will be described with reference to FIGS. 1 and 8.

In step 802, an application program is selected. In step 805, the resource broker 102 selects a virtual resource 109 that has been purchased for the selected application program. Then, in step 810, the resource broker 102 allocates the purchased virtual resource 109 to the application program, and, in step 815, the requirements broker 114 instructs the application program to utilize the allocated virtual resource 109 for operation of the application program.

In step 820, the method 245 determines whether another resource was purchased for the application program. If yes, then the method 245 branches back to step 805 to allocate another virtual resource 109 to the application program. If not, then the method 245 branches to step 825.

In step 825, the method 245 determines whether to migrate another application program's operations to purchased resources. If yes, then the method 245 branches back to step 802 to select another application program. If not, then the method 245 branches to step 250 (FIG. 2).

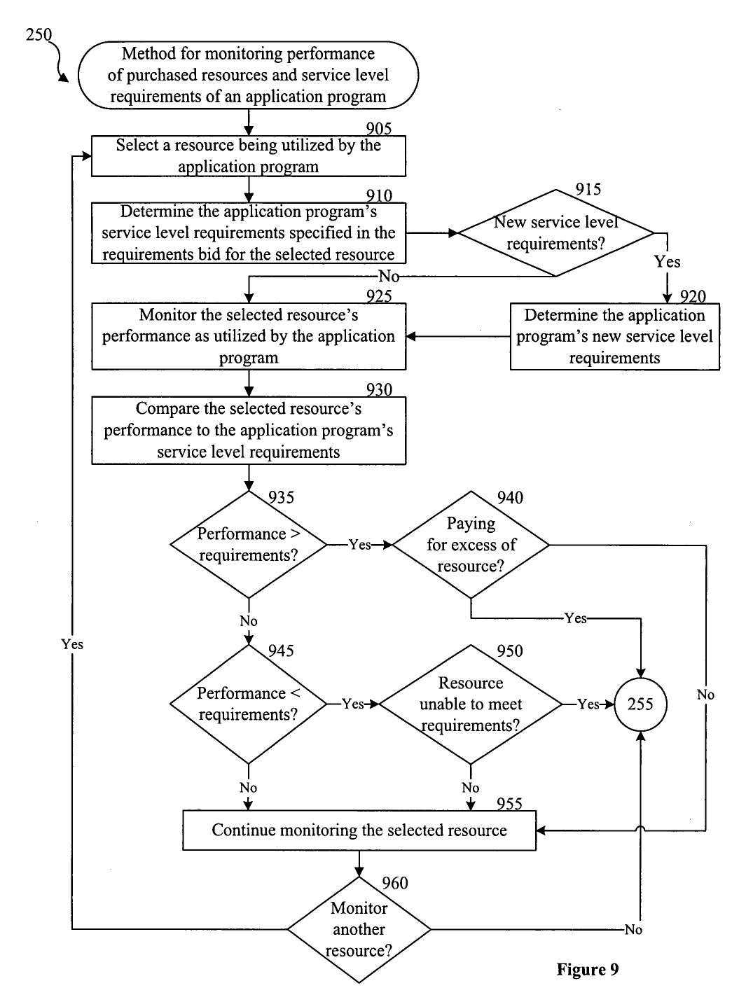

FIG. 9 is a flow chart depicting a method 250 for monitoring the performance of allocated resources and the service level requirements of an application program according to an exemplary embodiment of the invention, as referred to in step 250 of FIG. 2. The method 250 will be described with reference to FIGS. 1 and 9.

In step 905, the requirements broker 114 selects a resource being utilized by the application program. For example, the requirements broker 114 can select one of the computing, network, or storage resources being utilized by the application program.

In step 910, the requirements broker 114 determines the application program's service level requirements specified in the requirements bid for the selected resource. In an exemplary embodiment, the requirements broker 114 can make that determination based on the service level requirements listed in the service level agreement. Then, in step 915, the requirements broker 114 determines whether new service level requirements (other than the service level requirements specified in the requirements bid for the selected resource) have been established for this resource. If yes, then the method 250 branches to step 920 to determine the application program's new service level requirements, for example, by reading the new requirements input by a user of the application program. The method 250 then proceeds to step 925. Referring back to step 915, if the requirements broker 114 determines that new service level requirements for the application program have not been established, then the method 250 can branch directly to step 925.

In step 925, the requirements broker 114 monitors the selected resource's performance as utilized by the application program. In step 930, the requirements broker 114 compares the selected resource's performance to the application program's service level requirements. Then, in step 935, the requirements broker 114 determines whether the resource's performance exceeds the application program's service level requirements. If yes, then the method branches to step 940.

In step 940, the requirements broker 114 determines whether it is paying for an excess of the resource. For example, the requirements broker 114 can determine that it is paying for an excess of the resource if the application program is operating at or near its maximum utilization of the resource and the resource has excess capacity. Alternatively, if the resource has excess capacity but the application program currently is operating below its maximum utilization of the resource, then the requirements broker 114 can determine that it is not paying for an excess of the resource. If the requirements broker 114 determines that it is paying for an excess of the resource, then the method 250 branches to step 255 (FIG. 2) in which the requirements broker 114 determines that it is paying for under-utilized resources.

Referring back to step 940, if the requirements broker 114 determines that it is not paying for an excess of the resource, then the method 250 branches to step 955 to continue monitoring the selected resource.

Referring back to step 935, if the requirements broker 114 determines that the resource's performance is not exceeding the application program's service level requirements, then the method 250 branches to step 945. In step 945, the requirements broker 114 determines whether the selected resource's performance is not meeting the application program's service level requirements. If yes, then the method branches to step 950 in which the requirements broker 114 determines whether the resource is unable to meet the service level requirements. For example, the requirements broker 114 can determine that the selected resource is unable to meet the service level requirements if the application program is operating at or below its maximum utilization of the resource and the resource is not providing sufficient performance to meet the service level requirements. Alternatively, if the application program is temporarily operating beyond the utilization specified in the service level requirements, then the requirements broker 114 can determine that the resource is able to meet the service level requirements. If the requirements broker 114 determines that the resource is unable to meet the service level requirements, then the method 250 branches to step 255 (FIG. 2) in which the requirements broker 114 determines that it is paying for under-performing resources.

Referring back to step 950, if the requirements broker 114 determines that it is not paying for an excess of the resource, then the method 250 branches to step 955 to continue monitoring the selected resource.

Referring back to step 945, if the requirements broker 114 determines that the resource's performance is not less than the service level requirements, then the method 250 branches to step 955 to continue monitoring the selected resource.

From step 955, the method 250 proceeds to step 960 in which the requirements broker 114 determines whether to monitor the performance of another resource being utilized by the application program. If yes, then the method 250 branches back to step 905 to select another resource for monitoring. If not, then the method branches to step 255 (FIG. 2) in which the requirements broker 114 can determine that the resources utilized by the application program are not under-utilized or under-performing.

The method 250 can be performed for each application program that has been allocated resources in the distributed computing environment via service level agreements. In this manner, the performance of the allocated resources is continually or periodically monitored to ensure that the resources meet the service level requirements. If the resources are not providing the required level of service, then the requirements broker 114 generates new requirements bids 118 and submits those bids to the market exchange 112 to obtain resources that will meet the service level requirements. Additionally, in this manner, the performance of the allocated resources is continually or periodically monitored to ensure that the performance of the resources does not exceed the service level requirements by an amount that would indicate the requirements broker 114 is paying for unused resources (in other words, excess capacity of the resource). If the resources are not being sufficiently utilized by the application program, then the requirements broker 114 generates new requirements bids 118 and submits those bids to the market exchange 112 to obtain resources that are more suitable and/or economical with regard to the service level requirements.

The method 250 illustrated in FIG. 9 monitors the performance of allocated resources to determine whether those resources are under-utilized or under-performing. If so, then the method 250 returns to the method 200 illustrated in FIG. 2 to perform steps 225-245. In steps 225-245 of the method 200, new resources are identified and allocated to the application program, and the application program's operations are migrated to the new resources.

FIG. 10 is a block diagram depicting reallocation of distributed computing resources for an application program in the system 100 according to an exemplary embodiment of the invention. As illustrated in FIG. 10, the requirements broker 114 has identified a breach in the service level agreement for currently allocated network and storage virtual resources 109. In other words, the performance of the currently allocated network and storage virtual resources 109 is not meeting the service level requirements specified the service level agreement related to those virtual resources 109. More specifically, the virtual network fabric N₂ is not sufficient to provide the necessary communication rates between allocated resources, and the requirements broker 114 needs to obtain faster network resources. Additionally, the virtual storage fabric S₂ is not sufficient to provide the necessary storage and retrieval rates, and the requirements broker 114 needs to obtain more resilient storage resources.

Accordingly, the requirements broker 114 generates new requirements bids 118 to obtain new network and storage resources that can meet the specified service level requirements and submits those bids to the market exchange 112. The market exchange 112 identifies matching resource offers 110 and completes a service level agreement to allocate new network and storage virtual resources 109 to the application program. Then, the operations of the application program are migrated to the new network and storage virtual resources 109. As illustrated in FIG. 10, the application program's operations are migrated from virtual network fabric N₂ to virtual network fabric N₁ and from virtual storage fabric S₂ to virtual storage fabric S₁.

Also as illustrated in FIG. 10, the requirements broker 114 has identified a breach in the budget for currently allocated compute virtual resources 109. In other words, the performance of the currently allocated virtual compute fabric C₁ is exceeding the service level requirements specified in the service level agreement related to those resources. More specifically, the requirements broker 114 is over-paying for unused compute resources and needs to obtain new resources that perform within the service level requirements, which likely will reduce the cost to operate the application program.

Accordingly, the requirements broker 114 generates one or more new requirements bids 118 to obtain new compute resources that perform within the specified service level requirements and submits those bids to the market exchange 112. The market exchange 112 identifies matching resource offers 110 and completes a service level agreement to allocate new compute virtual resources 109 to the application program. Then, the operations of the application program are migrated to the new compute virtual resources 109. As illustrated in FIG. 10, the application program's operations are migrated from virtual compute fabric C₁ to virtual compute fabric C₂.

FIG. 11 is a flow chart depicting a method 270 for managing the maintenance, acquisition, and/or divestment of resources based on resource allocation over a period of time according to an exemplary embodiment of the invention, as referred to in step 270 of FIG. 2. The method 270 will be described with reference to FIGS. 1 and 11.

In step 1150, a resource manager, such as the resource broker 102, monitors revenue generated by each physical resource 103. In an exemplary embodiment, the resource manager can monitor such generated revenue by aggregating payments for service level agreements that correspond to each particular physical resource 103. Each payment represents an amount paid by the requirements broker 114 to the resource broker 102 for utilization of a particular physical resource 103 that is included in a service level agreement. In that regard, the resource manager can maintain a running total of revenue generated by each physical resource 103 during the time period.

Then, in step 1110, the method determines whether the time period has elapsed. In exemplary embodiments, the time period can be quarterly, bi-annually, annually, or any other suitable time period for monitoring revenues generated by the physical resources 103. In another exemplary embodiment, the method 270 can determine whether the time period has elapsed based on a predetermined time period that is monitored by the resource broker 102, the expiration of which can trigger an alert that the time period has elapsed. Alternatively, the method 270 can determine whether the time period has elapsed based on a user manually accessing the generated revenue information from step 1105. In any event, if the time period has not elapsed, then the method 270 branches back to step 1105 to continue monitoring the revenue generated by each physical resource 103. If the time period has elapsed, then the method 270 branches to step 1115.

In step 1115, the method identifies costs and expenses associated with, among other things, procuring and maintaining each physical resource. In an exemplary embodiment, a user can input that information based on actual and/or projected procurement and maintenance costs. Then, in step 1120, the profit and loss of each physical resource 103 is determined by subtracting the costs and expenses associated with the physical resource 103 from the revenue generated by the physical resource 103.

In step 1125, a particular physical resource 103 is selected, and, in step 1130, it is determined whether the selected resource made a profit or loss during the time period. If the physical resource's revenue is greater than its costs and expenses, then the physical resource has generated a profit during the time period. Alternatively, if the physical resource's revenue is less than its costs and expenses, then the physical resource has generated a loss during the time period.

If the selected physical resource generated a profit, then the method 270 branches to step 1135. In step 1135, the profit of the selected physical resource is compared to the profit of other similar resources. Then, a determination is made in step 1140 whether to maintain the current position of the selected physical resource or to invest in the selected physical resource. For example, if the resource is making only a small profit compared to other resource, then the user may decide to maintain the current position in the resource. In other words, the user will not purchase more of the resource. Alternatively, if the resource made a large profit compared to other resources, or if the demand for the resource is projected to increase, then the user may decide to invest in the resource by purchasing more of the resource or upgrading the existing resource. After determining whether to maintain or invest in the position of the selected physical resource, the method 270 proceeds to step 1150.

Referring back to step 1130, if the selected physical resource generated a loss during the time period, then the method 270 branches to step 1145. In step 1145, a determination is made whether to maintain the current position of the selected physical resource or to divest the selected physical resource. For example, if the resource experienced only a small loss, or if the resource meets a high priority need that justifies the cost, then the user may decide to maintain the current position in the resource. In other words, the user will not divest the resource. Alternatively, if the resource experienced a large, or otherwise undesirable, loss, then the user may decide to divest the resource by selling the resource or discontinuing the support or maintenance of the resource. In other embodiments, the user may decide to reduce use of the resource to reduce the loss associated with the resource, or the user may decide to subsidize continued use of the resource using profits generated by another resource. After determining whether to maintain or divest in the position of the selected physical resource, the method 270 proceeds to step 1150.

In step 1150, it is determined whether to evaluate the position of another resource. If yes, then the method 270 branches back to step 1125 to select another resource. If not, then the method 270, and the method 200 (FIG. 2), ends.

Accordingly, the method 270 allows a user to evaluate physical resources to determine which resources are the most economical, including both price and performance. For example, compute resources can comprise different platforms that each has different price and performance characteristics. Comparison of the profit and loss statements of each resource will show which platforms are used most by application programs, thereby generating more revenue. Based on that information, the user can determine which platforms to maintain or in which to increase a companies position and which platforms to divest. Because the resources have been allocated as described with reference to the method 200 (FIG. 2), the method 270 provides an indication of which resources are more desirable, based on price and performance characteristics, for use by application programs.

Although the invention has been described in detail with reference to allocation and management of distributed computer resources, the invention also applies to allocation and management of other distributed resources. For example, the invention also can apply to a distributed workforce. In this case, resource offers 110 are generated to identify characteristics and prices associated with available individual or group members of the workforce, and those offers are submitted to the market exchange 112. Requirements bids 118 are generated to obtain services from the workforce for a particular work project, and those bids are submitted to the market exchange 112. Then, the market exchange 112 identifies matching bids and offers and allocates the workforce resources to the project. The performance of the allocated resources can be monitored and the resources can be reallocated as necessary to correct for under-utilized or under-performing members of the workforce. Over time, the profit and loss of individual or group members of the workforce can be determined, and the profit and loss information can be used to determine investment or divestment decisions regarding particular aspects of the workforce.

The present invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described herein in detail, the description is merely for purposes of illustration. The exemplary methods described herein are merely illustrative and, in alternative embodiments of the invention, certain steps can be performed in a different order, performed in parallel with one another, or omitted entirely, and/or certain additional steps can be performed without departing from the scope and spirit of the invention. Additionally, various modifications of, and equivalent steps corresponding to, the disclosed aspects of the exemplary embodiments, in addition to those described herein, can be made by those skilled in the art without departing from the spirit and scope of the present invention defined in the following claims, the scope of which is to be accorded the broadest interpretation so as to encompass such modifications and equivalent structures.

What is claimed is:

1. A computer-implemented method for allocating computing resources, comprising the steps of:
creating a plurality of offers to provide a plurality of resources for use by any of a plurality of application programs, each of the offers specifying a unit of performance and a value associated with a corresponding resource;
creating a bid to obtain a unit of at least one resource for use by a specified application program, the bid specifying service level requirements required for operation of the specified application program and a value associated with operating the specified application program;
matching a particular one of the offers to the bid via a market exchange model by matching the service level requirements and value of the bid to the unit of performance and value of the particular one of the offers, thereby creating a matching offer;
allocating the resource corresponding to the matching offer to the specified application program, thereby creating an allocated resource; and
migrating operations of the specified application program to the allocated resource.

2. The method of claim 1, wherein the allocating step comprises issuing a service level agreement via which the resource corresponding to the matching offer is committed to the specified application program in exchange for payment of the value specified in the matching offer.

3. The method of claim 1, wherein the matching step comprises at least one of (a) revising at least one of the offers until the unit of performance and value specified in a revised offer matches the service level requirements and value specified in the bid, (b) revising the bid until the service level requirements and value specified in the revised bid matches the unit of performance and value specified in one of the offers, and (c) revising the bid and at least one of the offers until the service level requirements and value specified in the revised bid matches the unit of performance and value specified in a revised offer.

4. The method of claim 1, wherein the market exchange model comprises one of a commodity market model, a posted price model, a tendering/contract-net model, an auction model, a monopoly model, an oligopoly model, and a bid-based proportional resource sharing model.

5. The method of claim 1, further comprising the steps of:
determining whether the performance of the allocated resource complies with the service level requirements; and
replacing the allocated resource with a replacement resource in response to a determination that the performance of the allocated resource does not comply with the service level requirements.

6. The method of claim 5, wherein the replacing step comprises the steps of:
creating a new bid to obtain the replacement resource for use by the specified application program, the new bid specifying service level requirements required for operation of the specified application program and a value associated with operating the specified application program;
identifying the replacement resource by matching another one of the offers corresponding to the replacement resource to the new bid via the market exchange model; and
allocating the replacement resource to the specified application program.

7. The method of claim 5, wherein the determining step comprises at least one of (a) determining that the performance of the allocated resource does not comply with the service level requirements because the service level requirements specified in the bid have changed and (b) determining that the performance of the allocated resource does not comply with the service level requirements because the performance of the allocated resource exceeds the service level requirements.

8. The method of claim 1, wherein the resources comprise virtual resources.

9. A computer-readable medium having computer-executable instructions for performing the computer-implemented method of claim 1.

10. A system for allocating computing resources, comprising:
a resource broker configured to create a plurality of offers to provide a plurality of resources for use by an application program, each of the offers specifying a performance characteristics and a value associated with a corresponding resource;
a requirements module configured to create a bid to obtain at least one resource for use by a specified application program, the bid specifying service level requirements required for operation of the specified application program and a value associated with operating the specified application program; and
a market exchange configured to match at least one of the offers to the bid via a market exchange model by matching the service level requirements and value of the bid to the performance characteristics and value of respective ones of the offers, thereby identifying at least one matching offer,
wherein the resource broker is further configured to command allocation of each resource corresponding to the at least one matching offer to the specified application program, thereby creating one or more allocated resources, and
wherein the requirements broker is further configured to command migration of operations of the specified application program to the one or more allocated resources.

11. The system of claim 10, wherein the bid comprises a plurality of bids to obtain a plurality of resources for use by the specified application program.

12. The system of claim 10, wherein the market exchange is further configured to allow at least one of (a) the resource broker to revise at least one of the offers until the performance characteristics and value specified in a revised offer matches the service level requirements and value specified in the bid, (b) the requirements broker to revise the bid until the service level requirements and value specified in the revised bid matches the performance characteristics and value specified in one of the offers, and (c) the requirements broker to revise the bid and the resource broker to revise at least one of the offers until the service level requirements and value specified in the revised bid matches the performance characteristics and value specified in a revised offer.

13. The system of claim 10, wherein the market exchange is configured to identify the at least one matching offer by utilizing at least one of a commodity market model, a posted price model, a tendering/contract-net model, an auction model, a monopoly model, an oligopoly model, and a bid-based proportional resource sharing model.

14. The system of claim 10, wherein the requirements broker is further configured to determine whether the performance of the allocated resources complies with the service level requirements, and
wherein at least one of the allocated resources is replaced with a replacement resource in response to a determination that the performance of the allocated resources does not comply with the service level requirements.

15. The system of claim 14, wherein the market exchange is further configured to identify an offer corresponding to the replacement resource via the market exchange model.

16. The system of claim 14, wherein the requirements broker determines that the performance of the allocated resources does not comply with the service level requirements because the service level requirements specified in the bid have changed.

17. The system of claim 10, wherein the resources comprise virtual resources.

18. A computer-implemented method for allocating computing resources, comprising the steps of:
creating offers to provide virtual resources for use by application programs, each of the offers specifying a performance characteristic and a value associated with a corresponding resource;
creating bids to obtain resources for use by application programs, each bid specifying a service level requirement for operation of a corresponding application program and a value associated with operating the corresponding application program;
matching offers to bids via the market exchange model by matching the service level requirement and value of each of the bids to the performance characteristic and value of one of the offers, thereby creating pairs of matching offers and bids; and
allocating the resources based on the matching offers and bids.

19. The method of claim 18, wherein the matching step comprises at least one of (a) revising at least one of the offers until the performance characteristic and value specified in a revised offer matches the service level requirement and value specified in one of the bids, (b) revising at least one of the bids until the service level requirement and value specified in a revised bid matches the performance characteristic and value specified in one of the offers, and
(c) revising at least one of the bids and at least one of the offers until the service level requirements and value specified in a revised bid matches the unit of performance and value specified in a revised offer.

20. The method of claim 18, further comprising the step of migrating operations of the application programs to the allocated resources.

21. The method of claim 18, further comprising the steps of:
determining whether the performance of each of the allocated resources complies with the service level requirement specified in a corresponding one of the pairs of matching offers and bids, thereby identifying non-performing resources; and
replacing each of the non-performing resources with a replacement resource in response to a determination that the non-performing resource's performance does not comply with the corresponding service level requirement.

22. The method of claim 18, further comprising the steps of:
identifying each of the allocated resources that generated a profit during a time period; and
determining to invest in at least one of the resources that generated a profit during the time period.

23. The method of claim 22, wherein the identifying step comprises the steps of:
monitoring revenue generated by each of the allocated resources during the time period;
identifying costs and expenses associated with each of the allocated resources; and
subtracting each resource's costs and expenses from its generated revenue,
wherein the determining step determines that each resource having revenue greater than its costs and expenses generated a profit during the time period.

24. The method of claim 18, further comprising the steps of:
identifying each of the allocated resources that generated a loss during the time period; and
determining to divest at least one of the resources that generated a loss during the time period.

25. The method of claim 24, wherein the identifying step comprises the steps of:
monitoring revenue generated by each of the allocated resources during the time period;
identifying costs and expenses associated with each of the allocated resources; and
subtracting each resource's costs and expenses from its generated revenue,
wherein the determining step determines that each resource having revenue less than its costs and expenses generated a loss during the time period.
